(19) United States
(12) Patent Application Publication
(10) Pub. No.: US 2004/0176021 A1
(43) Pub. Date: Sep. 9, 2004

(54) Solar powered fresh air vehicle ventilation system

(76) Inventor: Derba Mills, San Antonio, TX (US)

Correspondence Address: Derba Mills, 8518 Timber West, San Antonio, TX, 78250, US

(21) Appl. No.: 10/379,050

(22) Filed: Mar. 4, 2003

(51) Int. Cl. B60H 1/26

(52) U.S. Cl. 454/143

(57) ABSTRACT

A solar powered fresh air vehicle ventilation system is disclosed. This invention relates to reducing the temperature of the interior of a vehicle parked in the sun. The embodiment of the invention includes a heating ventilation air conditioning blower/vacuum including a centrifugal fan driven by an electric motor. The electric motor is powered by photovoltaic cells. A temperature sensor and controller may activate the system An exhauster/intake vent allows the egress and ingress of fresh air into the vehicle's interior.

### CROSS-REFERENCE TO RELATED APPLICATIONS

References Cited
U.S. Patent Documents

| | | | |
|---|---|---|---|
| 4,202,396 | May 13, 1980 | Levy | 160/107 |
| 4,741,256 | May 03, 1988 | Huang | 98/2.14 |
| 5,344,361 | Sep. 06, 1994 | Matthias | 454/129 |
| 6,092,988 | Jul. 25, 2000 | Botros | 415/191 |
| 6,282,911 B1 | Sep. 04, 2001 | Watanabe et al. | 62/244 |
| 6,409,591 B1 | Jun. 25, 2002 | Sullivan et al. | 454/164 |
| 6,435,961 B1 | Aug. 20, 2002 | Biancone | 454/164 |

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Most, if not all, vehicles manufactured today have a heating and ventilation system for the interior of the vehicle. Most also include an air conditioning system. Air is blown into the interior of a vehicle for heating, ventilation, or cooling using a centrifugal fan powered by an electric motor. The electric motor is powered by the vehicle's charging system. Typically, the air intake for most vehicles is placed in the cowling area since the cowling area is opened to the atmosphere and covered by the front hood, but sealed away from the engine compartment by the front hood molding. Since the interior of vehicles is sealed from the exterior of the vehicle, most vehicles are equipped with an exhauster vent to relieve the excess air pressure inside the interior to the vehicle's exterior. The exhauster vent acts as a check valve to relieve the interior air pressure while preventing the ingress of air from the exterior of the vehicle. The exhauster vent is commonly located in the rear wheel well or in the vehicles rear trunk region adjacent to the rear bumper.

The vehicle's heating ventilation air conditioning (HVAC) system is dormant while the vehicle is not in operation. The temperature of a vehicle parked in the sun can reach 181 degrees Fahrenheit (° F.). Once started, the vehicle must be driven for a long time with the air conditioner blowing at the maximum fan speed and lowest temperature to cool down. The extreme temperature is stressful to the occupants. Some people experience fatigue or even physical illness from the exposure. The vehicles' contents, such as compact discs and cassette tapes, are often damaged inside a hot vehicle. Also, prolonged exposure to high temperatures damages the vehicle's dashboard, headliner and upholstery.

Prior art to handle this problem have typically included devices to deflect the sun's rays, such as reflective window tinting and windshield shades. The deflection devices have only been partly effective in solving the problem, since the temperature of the interior is still far above ambient temperature. Prior art has also included aerosol sprays to reduce the temperature when entering the vehicle. These devices are largely unused since the sprays must be purchased in advance, are toxic to the environment, and do not prevent damage to the vehicle's interior.

A few solar powered ventilation devices for automobiles are known in the prior art, with only one directed at releasing excessive heat from the vehicle's interior. U.S. Pat. No. 6,435,961 B1 to Biancone is directed at releasing excessive heat from the vehicle's interior using a solar powered fan mounted to the roof of the vehicle. While the devices may fulfill their respective, particular objective and requirements, the aforementioned patents do not employ optimum airflow to reduce the interior temperature of the vehicle parked in the sun. Specifically, none of the devices direct fresh air from cooler, shaded areas near the vehicle, and none use the vehicle's HVAC system.

Accordingly, a need still remains for an improved method to reduce the temperature of the interior of a vehicle parked in the sun.

### BRIEF SUMMARY OF THE INVENTION

The present invention reduces the temperature of the interior of a vehicle parked in the sun using solar photovoltaic cells to power a centrifugal fan that may be used to either blow cool air in, or vacuum hot air out, of the vehicle using components within the vehicle's heating ventilation air conditioning (HVAC) system.

This solar powered fresh air vehicle ventilation system is comprised of four primary components that include a centrifugal fan assembly, photovoltaic cells, a temperature sensor and controller, and exhauster/intake vent. The design may be adapted to fit any vehicle. FIG. 1 illustrates the primary system components.

These and additional objects, advantages, features, and benefits of the present invention will become apparent from the following specification.

### BRIEF DESCRIPTION OF SEVERAL VIEWS OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side perspective view of a vehicle according to the present invention.

FIG. 2 is a side sectional view of the centrifugal fan assembly in accordance with the prior art.

FIG. 3 is a side sectional view of the centrifugal fan assembly structured in accordance with the principles of the present invention.

### DETAILED DESCRIPTION OF THE INVENTION

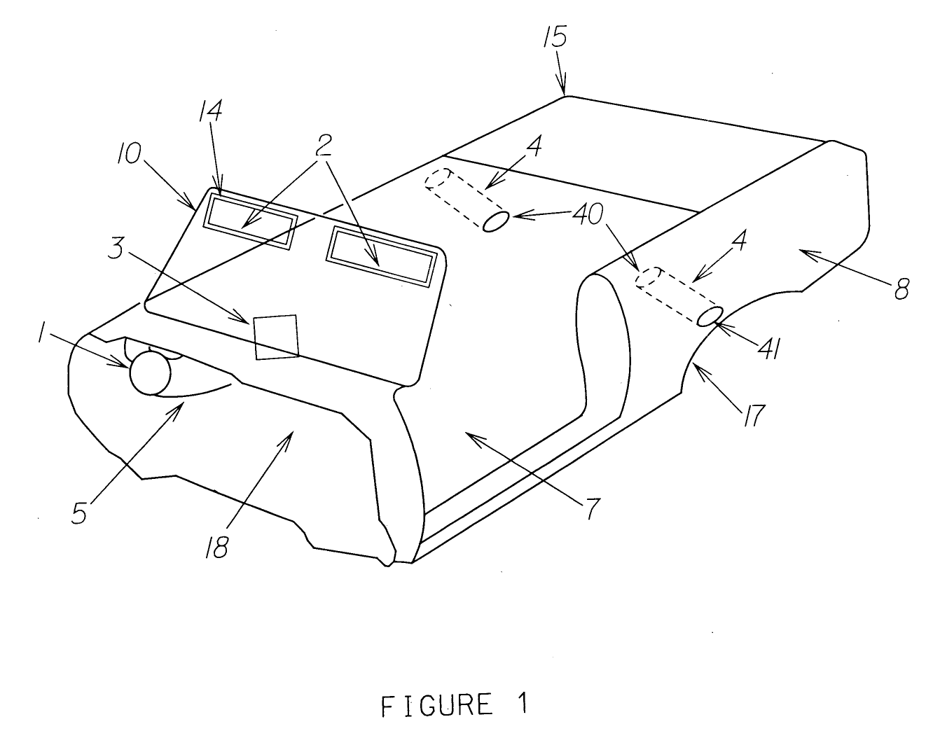

Referring to FIG. 1, a vehicle 15 according to the present invention has a body 8. Adjacent to the front end of the vehicle body 8 is an engine compartment (not shown). The engine compartment at its rear end is bordered by a firewall 18. The firewall forms a forward border for the interior 7. The interior 7 includes a generally sealed control volume of air when the vehicle's doors (not shown) and windows (not shown) are closed.

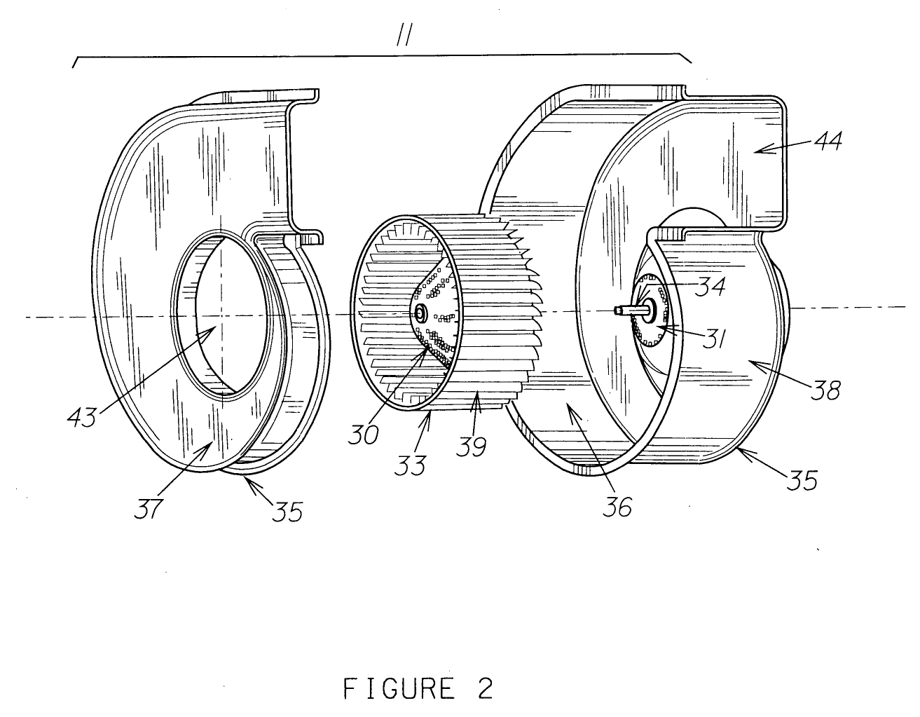

Mounted within the vehicle's interior 7 in an area underneath the dashboard (not shown) is a centrifugal fan assembly 1. FIG. 2 illustrates the centrifugal fan assembly 11 by prior art. The centrifugal fan assembly 11 is used to blow air into the interior 7 from the vehicle's heating ventilation and air conditioning (HVAC) system (not shown) and is powered by the vehicle's electrical charging system (not shown). The centrifugal fan assembly 11 typically induces pressurized air into the interior 7 from an inlet in the cowling (not shown) of the vehicle 15. The cowling is adjacent to the lower end of the front windshield 10. The centrifugal fan assembly 11 blows air into the interior 7 through the vehicle's HVAC ducts 5 and vents (not shown) while the vehicle 15 is in operation.

The object of the present invention is to reduce the temperature of a vehicle's interior 7 while the vehicle 15 is parked in the sun and not in operation. This solar powered fresh air vehicle ventilation system includes, among other components, a centrifugal fan assembly 1, photovoltaic cells 2, a temperature sensor and controller 3, and exhauster/intake vent 4. The design may be adapted to fit any vehicle.

The specification and figures for this invention describe a vehicle 15 with an engine, such as an automobile or truck. However, vehicles 15 with the present embodiment of this invention may include any device for conveying persons or objects and includes, but is not limited to, trailers, boats, and heavy equipment such as tractors, backhoes, and bulldozers.

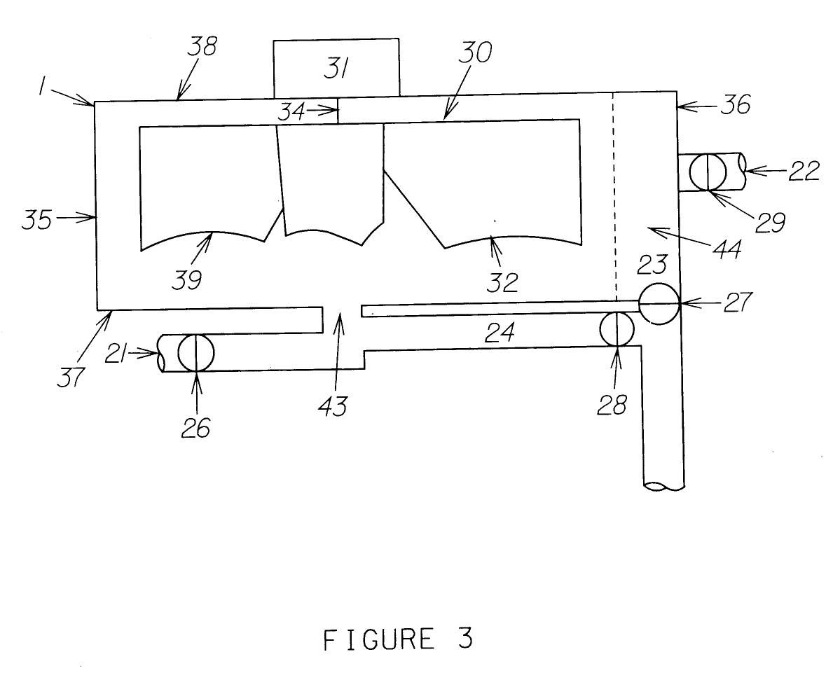

FIG. 3 shows side sectional view of the centrifugal fan assembly 1 according to the present invention. The centrifugal fan assembly I includes an electric motor 31 having a rotating shaft 34 protruding therefrom and into engagement with a fan hub 30, said motor being operative to rotate said fan hub 30 about an axis coincident with the axis of said rotating shaft 34. An impeller 32 with a plurality of fan blades 39 is disposed from the hub 30. The centrifugal fan assembly 1 may also use a fan wheel 33, as shown on the prior art in FIG. 2. The centrifugal fan assembly 1 includes a housing 35 for receiving said fan blades 39 and motor therein, said housing 35 having an air inlet 43 side 37, a motor receiving side 38 opposite said air inlet 43 side 37 and a generally curved wall 36 extending between the air inlet 43 side 37 and motor receiving side 38 and thereby defining a chamber through which a volume of air passes to fan outlet 44.

The centrifugal fan blower/vacuum 1 is connected to the vehicle's HVAC ducts 5 and vents, as well as a duct for outside air intake 21, and a duct for discharge to the outside 22. Four butterfly valves 26, 27, 28 and 29, or similar devices, are used to operate the unit as either a blower or a vacuum. Air is blown into the vehicle by opening the valves 26 and 27 to the outside air intake 21 and blower discharge 23, and closing the valves 28 and 29 to the vacuum duct 24 and vacuum discharge 22. Air is vacuumed out of the vehicle by opening valves 29 and 28 to the vacuum discharge 22 and vacuum duct 24, and closing the valves 27 and 26 to the blower discharge 23 and outside air intake 21. Since hot air rises, the vacuum system could be enhanced by also placing vacuum vents at the uppermost locations in the interior 7.

Vehicles 15 are equipped with temperature sensor and controller 3 as part of the vehicle's HVAC system. The valves 26, 27, 28, and 29 to operate the centrifugal fan unit 1 in the blower mode or vacuum mode are opened and closed using the vehicle's temperature sensor and controller 3.

Photovoltaic cells 2 mounted in the vehicle's visors 13 or other suitable place powers the electric motor 31 that drives the centrifugal fan hub 30 and impeller 32 or wheel 33. Ideally, the cells 2 should be mounted in a location at or near the top of the vehicle to allow the maximum sun exposure. The cell amperage should be matched to the requirements of the electric motor 31 for the centrifugal fan assembly 1. The photovoltaic cells 2 can be connected directly the electric motor 31 or to a rechargeable battery (not shown) that is connected to the electric motor 31. The photovoltaic cells 2 can also be used to supply supplemental power to the vehicle's battery (not shown) or vehicle or personal accessories when the vehicle is parked in the sun. Alternately, the electric motor 31 can be operated by other power sources, such as a second battery connected to the vehicles charging system The temperature sensor and controller 3 can be set to activate the centrifugal fan motor 31 when the inside temperature of the vehicle exceeds a preset differential above the ambient temperature of the intake air. For example, if the differential is set for 5° F. and the ambient temperature is 80° F., the centrifugal fan motor 31 will turn on at 85° F. The system is turned off when the temperature of the interior 7 is at or near the ambient temperature of the intake air. Alternately, the system could be set to activate at a preset temperature, or at a preset time. The system is turned off manually, or automatically when the vehicle is in operation.

The exhauster/intake vent 4 allows fresh air to replace the hot air that is vacuumed out of the vehicle's interior 7. The exhauster/intake vent end 41 to the exterior of the vehicle 15 is placed in a location to draw fresh air from the coolest location near the vehicle, such as the vehicle's underside. The exhauster/intake vent end 41 to the exterior of the vehicle 15 allows the ingress of air to the interior 7 when the system is operating in the vacuum mode, or the egress of air from the interior 7 when the system is operating in the blower mode. Hence the exhauster/intake vent end 41 should be located away from the outside air intake duct 21, or outside air discharge duct 22, or any emission or heat sources, such as the vehicle's exhaust system (not shown). The exhauster/intake vent end 40 to the interior 7 should be placed in a location, such as the back seat, that optimizes the flow of fresh air through the vehicle.

The centrifugal fan assembly 1 for the present invention described in the preceding paragraphs is based on using the housing 35 in the vacuum mode to vacuum hot air from the interior when the vehicle is parked in the sun. In the vacuum mode, fresh air is pulled into the vehicle through the exhauster/intake vent. The centrifugal fan assembly 1 would operate in the normal blower mode for heating, ventilation, and cooling when the vehicle is in operation and the electric motor 31 would be powered by the vehicles charging system.

In an alternate embodiment of the present invention, instead of the centrifugal fan assembly 1 described, a standard centrifugal fan assembly 11 used in prior art as a blower could operate as a vacuum by running the fan impeller 32 or wheel 33 backward by reversing the polarity of the fan motor 31. In such an embodiment, the air inlet to the centrifugal fan assembly 11 would ideally be placed in a shaded location on the underside of the vehicle.

Another alternate embodiment of the present invention would be to include a fan (not shown) inside the HVAC duct 5 blowing in the opposite direction as the HVAC blower, thereby vacuuming hot air from the interior 7.

Alternately, another embodiment of the present invention the system would be to operate centrifugal fan assembly 1 in the blower mode by blowing fresh air into the interior 7 instead of vacuuming the hot air out. A centrifugal fan assembly 11 used in prior art could be used and the electric motor 31 would be powered by the photovoltaic cells 2. The hot air would be discharged through the vehicle's exhauster vents 12.

The embodiment of the present invention can be manufactured as part of a new vehicle or as a stand-alone system for after market sale. If built as a stand alone system, a fan and temperature sensor and controller (not shown) that attaches directly to a vehicles existing HVAC vent system could be used instead of the centrifugal fan assembly 1. For fresh air intake, a vent could be installed, or the vehicle's windows could be left slightly open.

While only one embodiment of the present invention has been shown and described, it will be understood that various modifications and changes could be made thereunto without departing from the spirit and scope of the invention.

With respect to the description above, it is to be realized that the optimum dimensional relationship for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered to be illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of this invention.

I claim:

1. A vehicle compromising:
a body enclosing a interior, said interior providing a generally sealed control volume, and wherein said vehicle body has a openings communicating with the exterior of the vehicle body; and
a ventilation system for inducing fresh air into said interior while the vehicle is parked in the sun;

2. A fresh air ventilation system according to claim 1, wherein said system includes a centrifugal fan assembly, photovoltaic cells, temperature sensor and controller, and a vent or vents to allow the ingress and/or egress of air into the vehicle.

3. A centrifugal fan assembly according to claim 2 compromising:
an electric motor having a rotating shaft protruding therefrom and into engagement with a fan hub, said motor being operative to rotate said fan hub about an axis coincident with the axis of said rotating shaft;
an impeller or fan wheel with a plurality of fan blades disposed from the hub; and
a housing for receiving said fan blades and motor therein, said housing having an air inlet side, a motor receiving side opposite said air inlet side and a generally curved wall extending between the air inlet side and motor receiving side and thereby defining a chamber through which a volume of air passes.

4. A centrifugal fan assembly with a housing according to claim 3 wherein said housing includes an outside air intake duct to control the ingress or egress of air through said housing.

5. A centrifugal fan assembly with a housing according to claim 3 wherein said housing includes an outside air discharge duct to control the ingress or egress of air through said housing.

6. A centrifugal fan assembly with a housing according to claim 3 wherein said housing includes a blower duct to control the ingress or egress of air through said housing.

7. A centrifugal fan assembly with a housing according to claim 3 wherein said housing includes a vacuum duct to control the ingress or egress of air through said housing.

8. A centrifugal fan assembly with a housing according to claim 3 wherein said housing includes valves to control the ingress or egress of air through said housing.

9. A centrifugal fan assembly with a housing according to claim 3 wherein said housing includes an outside air intake duct, an outside air discharge duct, a blower duct, a vacuum duct, and valves to control the ingress or egress of air through the vehicle's interior.

10. A centrifugal fan assembly with a housing according to claim 3 wherein said fan vacuums air from the interior of the vehicle through the vehicle's heating ventilation and air conditioning ducts.

11. A centrifugal fan assembly with a housing according to claim 3 wherein said fan blows air into the interior of the vehicle through the vehicle's heating ventilation and air conditioning ducts.

12. A centrifugal fan assembly with a housing according to claim 3 wherein said fan discharges air from the interior to the exterior of the vehicle through a duct.

13. A centrifugal fan assembly with a housing according to claim 3 wherein said fan discharges air into the interior from the exterior of the vehicle through a duct connected to a cooler location on the vehicle, such as the vehicle's underside.

14. A centrifugal fan assembly according to claim 3 wherein said fan motor is powered by photovoltaic cells.

15. A panel of photovoltaic cells according to claim 2 that supplies power to the centrifugal fan motor when the vehicle is parked in the sun.

16. A panel of photovoltaic cells according to claim 2 that supplies supplemental power to the vehicles battery when the vehicle is parked in the sun.

17. A panel of photovoltaic cells according to claim 2 that supplies power for vehicle or personal accessories when the vehicle is parked in the sun.

18. A centrifugal fan assembly according to claim 3 wherein said fan motor is activated by a temperature sensor and controller set at a preset temperature.

19. A centrifugal fan assembly according to claim 3 wherein said fan motor is activated by a temperature sensor and controller set at a preset temperature differential above ambient temperature

20. A centrifugal fan assembly according to claim 3 wherein a timer activates said fan motor at a scheduled time.

21. A vent according to claim 2 that allows the egress of air from the interior when the centrifugal fan is blowing air into the interior.

22. A vent according to claim 2 that allows the ingress of air into the interior when the centrifugal fan is vacuuming air from the interior.

23. A fresh air ventilation system wherein said system includes a centrifugal fan assembly, a panel of photovoltaic cells, temperature sensor and controller, and a vent or vents to allow the ingress and/or egress of air into an area.

24. A fresh air ventilation system according to claim 1, wherein said system includes a centrifugal fan assembly

25. A fresh air ventilation system according to claim 1, wherein said system includes a panel of photovoltaic cells

26. A fresh air ventilation system according to claim 1, wherein said system includes a temperature sensor and controller

27. A fresh air ventilation system according to claim 1, wherein said system includes a vent or vents to allow the ingress and/or egress of air into the vehicle.

28. A fresh air ventilation system according to claim 1, wherein said system includes a centrifugal fan assembly that operates a vacuum by running the fan impeller or wheel backward by reversing the polarity of the fan motor.

29. A fresh air ventilation system according to claim 1, wherein said system includes a fan inside the HVAC duct blowing in the opposite direction as the HVAC blower.

30. A fresh air ventilation system according to claim 1, wherein said system includes a centrifugal fan assembly, powered by photovoltaic cells, that blows fresh air into the interior and discharges hot air through the vehicle's exhauster vents.

31. A fresh air ventilation system according to claim 1, wherein said system includes a fan that attaches directly to a vehicle's existing HVAC vent system.
